(19) United States
(12) Patent Application Publication
(10) Pub. No.: US 2014/0208262 A1
(43) Pub. Date: Jul. 24, 2014

(54) DYNAMIC CONTROL METHOD FOR RESIZING SUB-WINDOWS ON A SCREEN OF A DISPLAY

(71) Applicant: Acti Corporation, Taipei City (TW)

(72) Inventors: YAN-HAO HUANG, TAIPEI CITY (TW); CHING-WEN LI, NEW TAIPEI CITY (TW)

(73) Assignee: Acti Corporation, Taipei City (TW)

(21) Appl. No.: 14/162,305

(22) Filed: Jan. 23, 2014

(30) Foreign Application Priority Data
Jan. 23, 2013 (TW) 102102509

(51) Int. Cl. G06F 3/0481; G06F 3/0486

(52) U.S. Cl. CPC G06F 3/0481; G06F 3/0486
USPC 715/800

(57) ABSTRACT

A dynamic control method for resizing sub-windows on a screen of a display is based on an intuitive drag-and-drop action to enlarge/shrink a sub-window and executed in a monitoring system, comprising steps as follows: pick a focal window, which presents a drag pane with at least a scale icon on its border, on a first split screen layout via a pointer tool; pick and hold one of the at least a scale icon as a drag origin with the pointer tool and activate a drag action from the drag origin to enlarge the drag pane to approximately match a corresponding first sub-window on a second split screen layout; after completing the drag action, the first sub-window is displayed on the screen and a channel image in the focal window will be transmitted to the corresponding first sub-window on the second split screen layout

### BACKGROUND

1. Technical Field

A dynamic control method for resizing sub-windows on a screen of a display, particular a control method for properly transferring any split screen layout to another one based on the extent of dragging a drag pane.

2. Descriptions of the Related Art

The IT equipment evolving with technical development has presented good performance and easily executed a number of operations synchronously, for example, the common digital security monitoring system with several monitors installed provides multiple monitoring video channels to record real-time status around different corners in an environment. However, in the past the monitoring system with multiple monitoring video channels providing images from more than one video camera for no dead space was equipped with a number of monitors, each of which corresponds to a single channel for multi-channel monitoring simultaneously (not shown in the figure). These days one monitor (FIG. 1) including a split screen layout to concentrate and display several monitoring video channels simultaneously by which a user is able to control status in different corners for early warning and immediate handling of any exceptional event.

The so-called split screen layout is intended to separate a display's limited screen space into multiple sub-windows, each of which displays a distinct monitoring video channel for a monitoring purpose. Currently, a monitoring system comprises several types of split screen layouts (as shown in FIG. 2).

However, the issue existing in a monitoring system under current split screen technology is that a specific sub-window picked and enlarged on a split screen layout occupies a display's most screen space and makes other sub-windows concealed and not displayed on the same screen. As such, monitoring video channels displayed on other sub-windows except the specific sub-window enlarged cannot be monitored simultaneously.

Accordingly, how to freely resize a certain sub-window for any exceptional status monitored by a user and to make remaining monitoring video channels corresponding to other sub-windows simultaneously displayed on the same screen under current split screen technology deserves to be studied by the persons skilled in the art.

### SUMMARY

A dynamic control method for resizing sub-windows on a screen of a display in one embodiment is based on an intuitive drag-and-drop action to enlarge a sub-window and executed in a monitoring system with at least two default split screen layouts, comprising steps as follows:

Step 1: Pick a focal window, which presents a first drag pane with at least a scale icon on its border, on a first split screen layout via a first pointer tool;

Step 2: Pick and hold one of the at least a scale icon as a drag origin with the first pointer tool and activate a drag action outward from the drag origin to enlarge the first drag pane;

Step 3: Enlarge the first drag pane to approximately match a corresponding first sub-window on a second split screen layout; and

Step 4: After a user completes the drag action, the first sub-window is displayed on the screen and a channel image in the focal window on the first split screen layout will be transmitted to the first sub-window on the second split screen layout for monitoring an enlarged sub-window.

A dynamic control method for resizing sub-windows on a screen of a display in another embodiment is based on an intuitive drag-and-drop action to shrink a sub-window and executed in a monitoring system with at least two default split screen layouts, comprising steps as follows:

Step 5: Pick a scalable window, which presents a second drag pane with at least a scale icon on its border, on a third split screen layout via a second pointer tool;

Step 6: Pick and hold one of the at least a scale icon as a drag origin with the second pointer tool and activate a drag action inward from the drag origin to shrink the second drag pane;

Step 7: Shrink the second drag pane to approximately match a corresponding second sub-window on a fourth split screen layout; and

Step 8: After a user completes the drag action, the second sub-window is displayed on the screen and a channel image in the scalable window on the third split screen layout will be transmitted to the second sub-window on the fourth split screen layout for monitoring a shrunk sub-window.

According to the major properties mentioned above, the pointer tool can be a mouse, a touchpad, a touch pen or a finger; a display screen on which a split screen layout is presented should be a touch screen in the case of a touch pen or a finger taken as the pointer tool.

### BRIEF DESCRIPTION OF THE DRAWINGS

FIG. 1 is a schematic view illustrating multiple monitoring video channels displayed on a split screen layout in a conventional security monitoring system simultaneously.

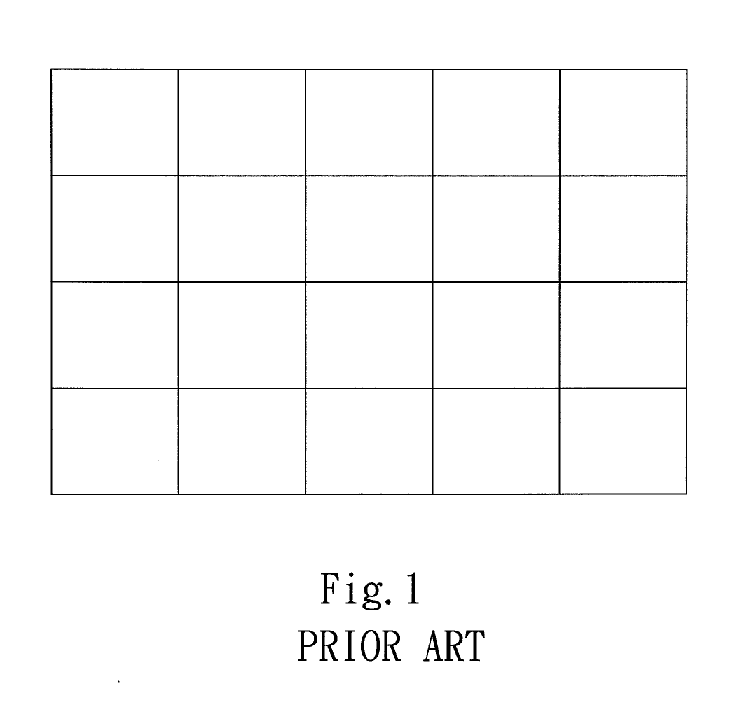

FIG. 2 is a schematic view illustrating several split screen layouts saved in a conventional security monitoring system.

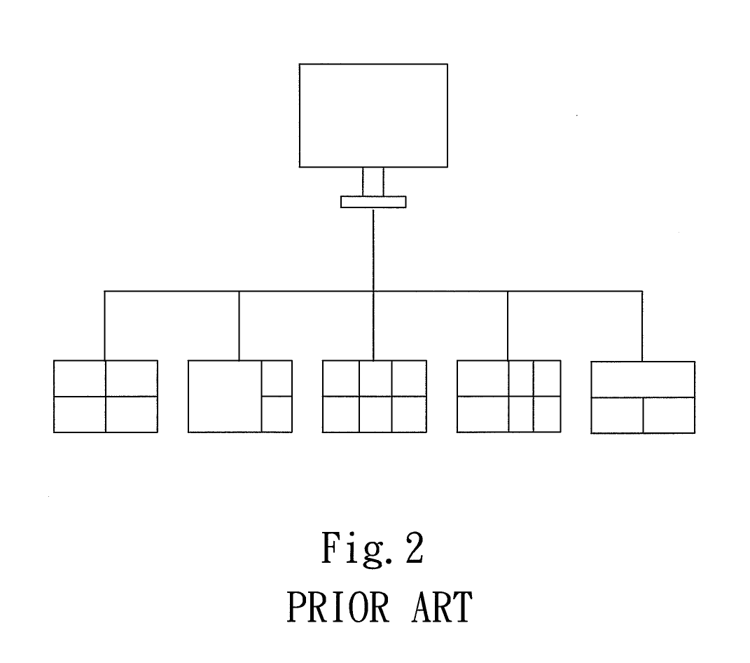

FIG. 3 is a flow diagram illustrating a dynamic control method for resizing sub-windows on a screen of a display.

FIG. 4 is a schematic view illustrating Step 1 of a dynamic control method for resizing sub-windows on a screen of a display.

FIG. 5 is a schematic view illustrating Step 2 of a dynamic control method for resizing sub-windows on a screen of a display.

FIG. 6 is a schematic view illustrating Step 3 of a dynamic control method for resizing sub-windows on a screen of a display.

FIG. 7 is a schematic view illustrating Step 4 of a dynamic control method for resizing sub-windows on a screen of a display.

FIG. 8 is another flow diagram illustrating a dynamic control method for resizing sub-windows on a screen of a display.

FIG. 9 is a schematic view illustrating Step 5 of a dynamic control method for resizing sub-windows on a screen of a display.

FIG. 10 is a schematic view illustrating Step 6 of a dynamic control method for resizing sub-windows on a screen of a display.

FIG. 11 is a schematic view illustrating Step 7 of a dynamic control method for resizing sub-windows on a screen of a display.

FIG. 12 is a schematic view illustrating Step 8 of a dynamic control method for resizing sub-windows on a screen of a display.

### DETAILED DESCRIPTION

The technical measures and effects are particularly presented in the preferred embodiments and accompanying drawings to realize the above purposes.

A dynamic control method for resizing sub-windows on a screen of a display herein is applicable to a monitoring system.

A pointer tool described in a dynamic control method for resizing sub-windows on a screen of a display herein can be a mouse, a touchpad, a touch pen or a user's finger. In the case of a touch pen or a finger as the pointer tool used in a dynamic control method for resizing sub-windows on a screen of a display, the display screen on which a split screen layout is presented should be a touch screen.

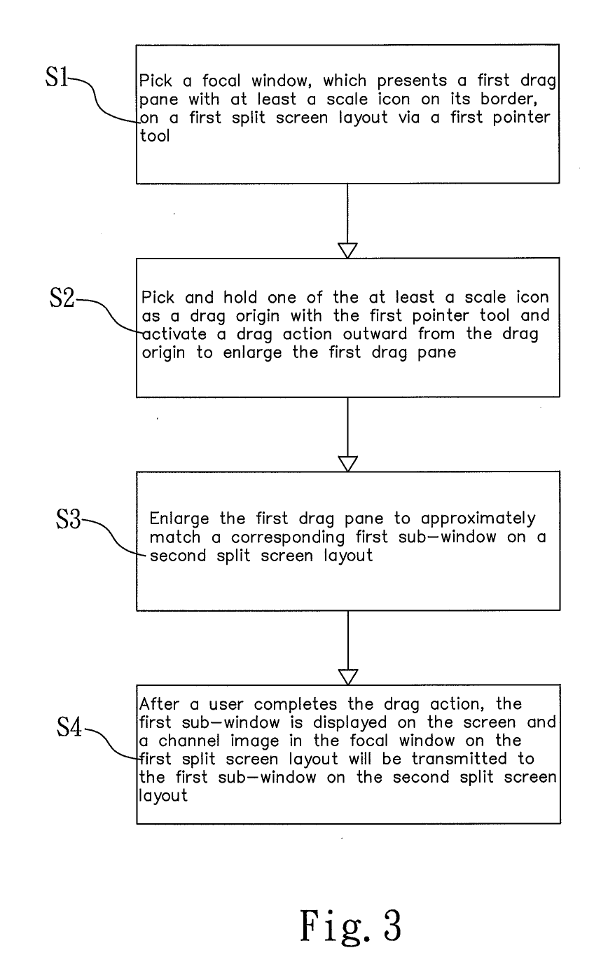

Refer to FIG. 3 through FIG. 7 which illustrates an embodiment of a dynamic control method for resizing sub-windows on a screen of a display executed in a monitoring system with a number of default split screen layouts, each of which comprises a number of sub-windows. For features of a dynamic control method for resizing sub-windows on a screen of a display clearly described herein, a first split screen layout 1 and a second split screen layout 2 should be defined first: the first split screen layout 1 is a split screen layout in which a sub-window to be enlarged is located;

the second split screen layout 2 is a split screen layout in which an enlarged sub-window is located.

The method comprises at least steps as follows:

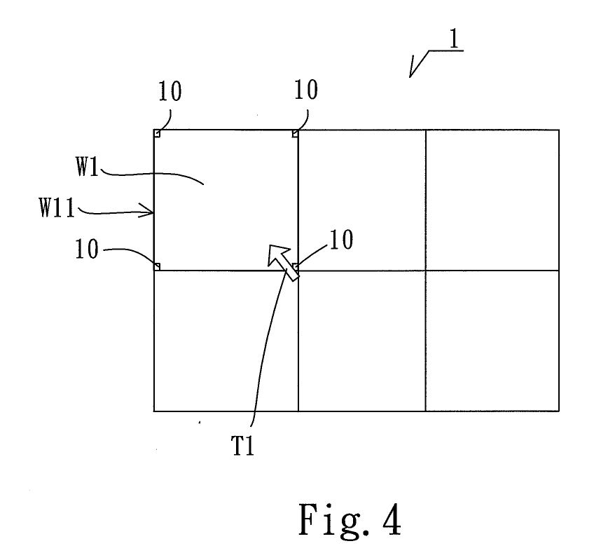

Step 1: For any sub-window to be enlarged, pick a focal window W1, which presents a first drag pane W11 with at least a scale icon 10 on its border that displays a distinct color different from that of the focal window W1, on a first split screen layout 1 via a first pointer tool T1 (S1) (as shown in FIG. 4);

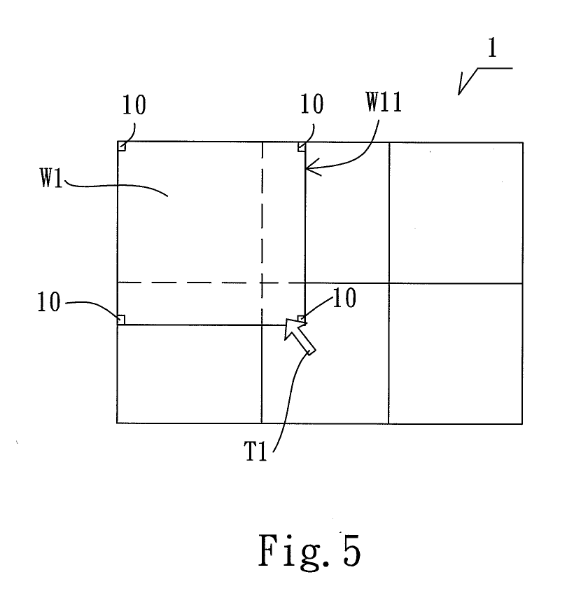

Step 2: Pick and hold one of the at least a scale icon 10 as a drag origin with the first pointer tool T1 and activate a drag action outward from the drag origin to enlarge the first drag pane W11 (S2) (as shown in FIG. 5);

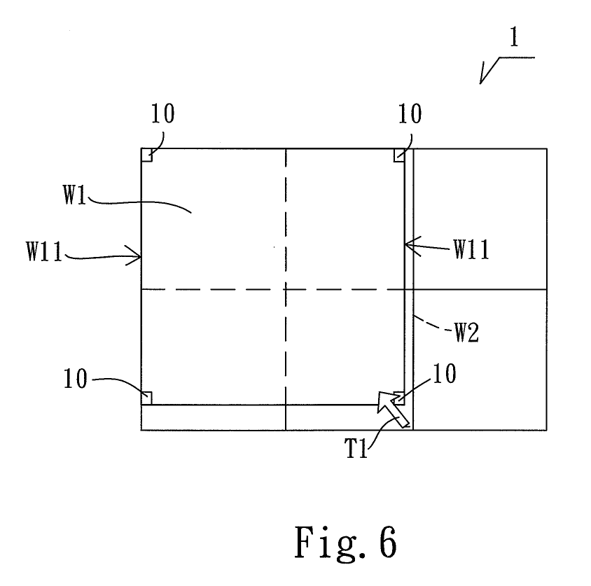

Step 3: Enlarge the first drag pane W11 to approximately match a corresponding first sub-window W2 on the second split screen layout 2 and make the first sub-window W2, the focal window W1 and the first drag pane W11 present borders with distinct colors (S3) (as shown in FIG. 6);

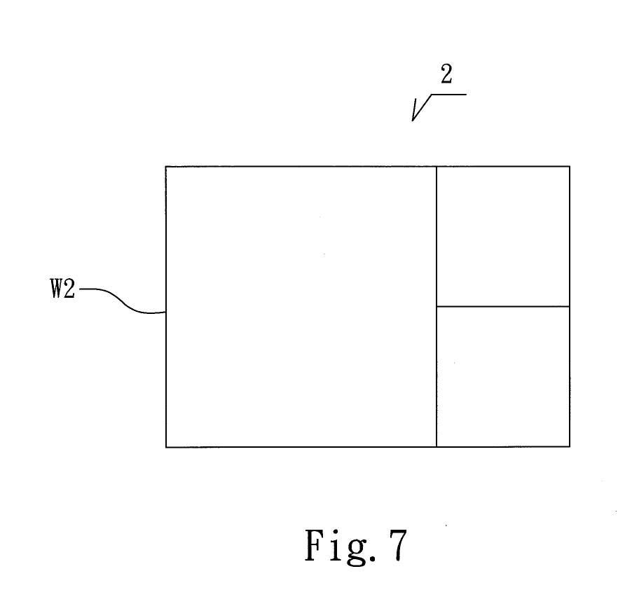

Step 4: After a user completes the drag action, the first sub-window W2 is displayed on the screen and a channel image in the focal window W1 on the first split screen layout 1 will be transmitted to the first sub-window W2 on the second split screen layout 2 for monitoring an enlarged sub-window (S4) (as shown in FIG. 7).

The first split screen layout 1 in Step 1 is a split screen layout on a display screen in which sub-windows are picked by a user but is not limited to a specific split screen layout. With a sub-window on the first split screen layout 1 clicked by a user using the first pointer tool T1, the sub-window is defined as the focal window W1 around which the first drag pane W11 with at least a scale icon 10 is created (as shown in FIG. 4).

An action to enlarge the first drag pane W11 in Step 2 depends on a direction to drag the first pointer tool T1 and allows the first drag pane W11 to be enlarged according to the original size of the focal window W1 in Step 1 (as shown in FIG. 5).

Neither the second split screen layout 2 in Step 3 nor the first split screen layout 1 in Step 1 should be limited to a specific split screen layout. As shown in Step 4, a complete drag action will define the split screen layout as the second split screen layout 2 in which the first sub-window W2 is displayed when the first drag pane W11 is dragged and enlarged to approximately match the corresponding first sub-window W2 on the default second split screen layout 2 via the first pointer tool T1. The meaning of approximately match is not limited to exactly match a sub-window. In one embodiment, the method to identify two windows with approximately similar sizes includes, without limitation, one mode, for example, the first drag pane W11 with half the size through the identical size of the corresponding first sub-window W2 on the second split screen layout 2 should be considered as a resized window with its size approximately matching the first sub-window W2 (as shown in FIG. 6).

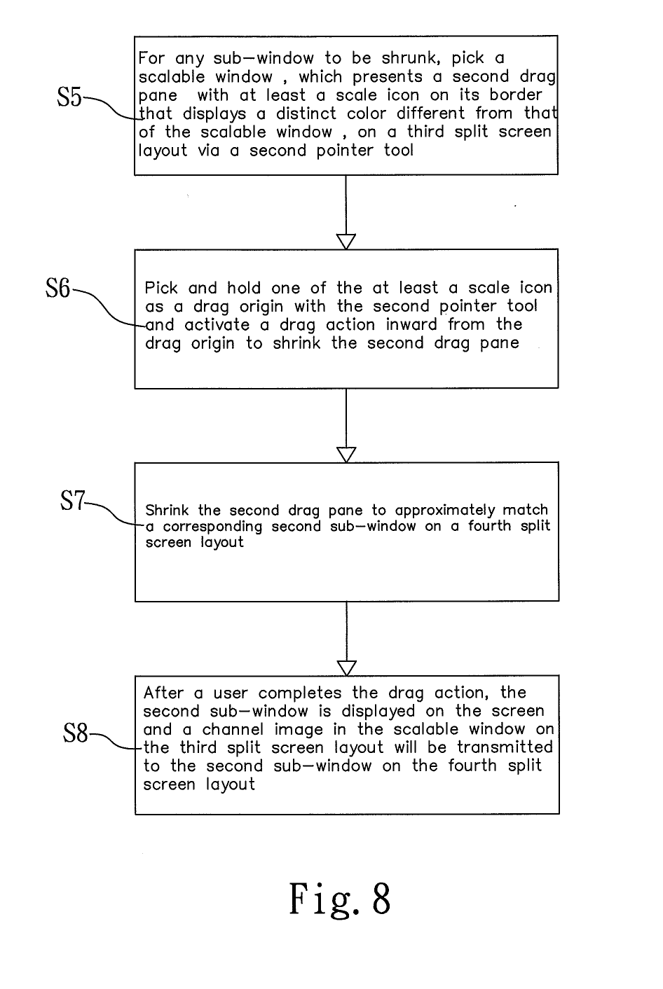

Another dynamic control method for resizing sub-windows on a screen of a display is indicated in an alternative embodiment. FIG. 8 is another flow diagram illustrating a dynamic control method for resizing sub-windows on a screen of a display. The method is executed in a monitoring system with a number of default split screen layouts, each of which comprises multiple sub-windows. For features of a dynamic control method for resizing sub-windows on a screen of a display clearly described herein, a third split screen layout 3 and a fourth split screen layout 4 should be defined first: the third split screen layout 3 is a split screen layout in which a sub-window to be shrunk is located; the fourth split screen layout 4 is a split screen layout in which a shrunk sub-window is located.

The method comprises at least steps as follows:

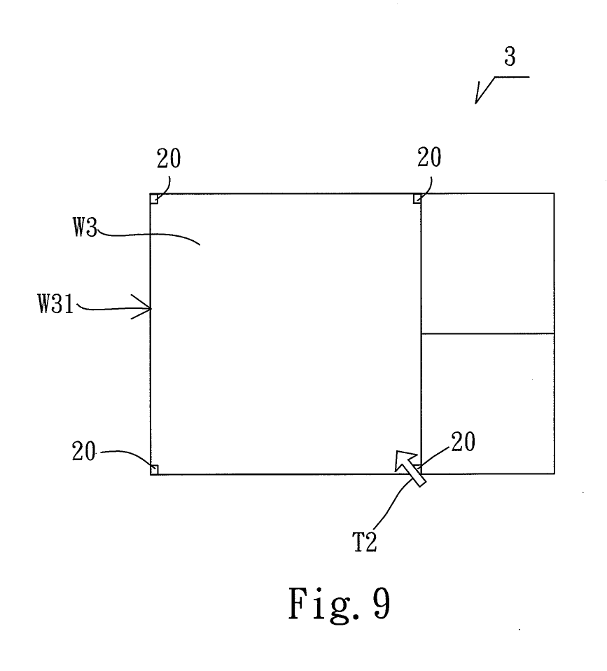

Step 5: For any sub-window to be shrunk, pick a scalable window W3, which presents a second drag pane W31 with at least a scale icon 20 on its border that displays a distinct color different from that of the scalable window W3, on a third split screen layout 3 via a second pointer tool T2 (S5) (as shown in FIG. 9);

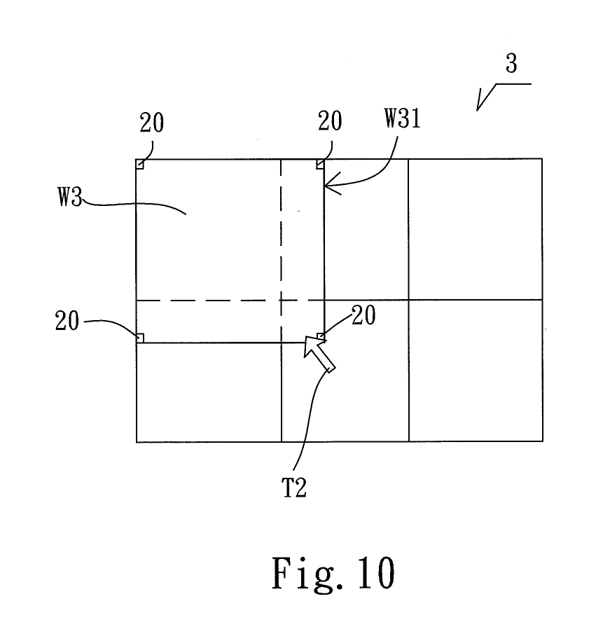

Step 6: Pick and hold one of the at least a scale icon 20 as a drag origin with the second pointer tool T2 and activate a drag action inward from the drag origin to shrink the second drag pane W31 (S6) (as shown in FIG. 10);

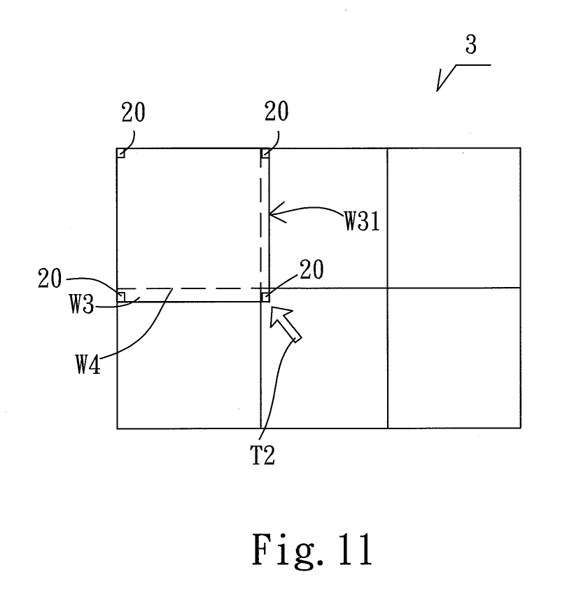

Step 7: Shrink the second drag pane W31 to approximately match a corresponding second sub-window W4 on the fourth split screen layout 4 and make the second sub-window W4, the scalable window W3 and the second drag pane W31 present borders with distinct colors (S7) (as shown in FIG. 11);

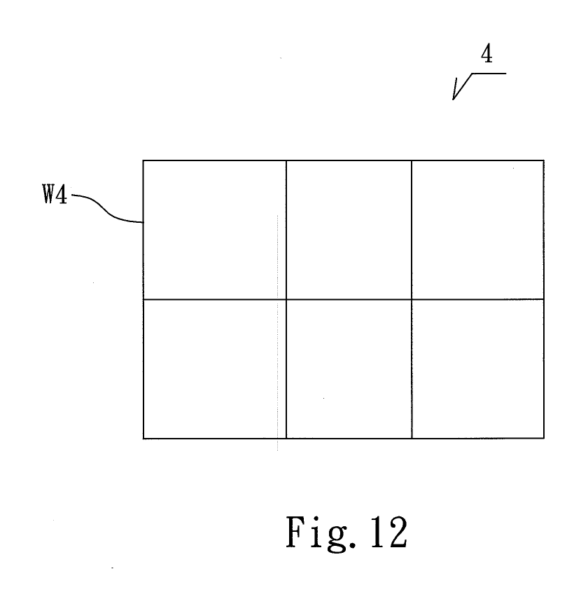

Step 8: After a user completes the drag action, the second sub-window W4 is displayed on the screen and a channel image in the scalable window W3 on the third split screen layout 3 will be transmitted to the second sub-window W4 on the fourth split screen layout 4 for monitoring a shrunk sub-window (S8) (as shown in FIG. 12).

The third split screen layout 3 in Step 5 is a split screen layout on a display screen in which sub-windows are picked by a user but is not limited to a specific split screen layout (as shown in FIG. 9).

An action to shrink the second drag pane W31 in Step 6 depends on a direction to drag the second pointer tool T2 and allows the second drag pane W31 to be shrunk according to the original size of the scalable window W3 in Step 5 (as shown in FIG. 10).

Neither the fourth split screen layout 4 in Step 7 nor the third split screen layout 3 in Step 5 should be limited to a specific split screen layout. As shown in Step 8, a complete drag action will define the split screen layout as the fourth split screen layout 4 in which the second sub-window W4 is displayed when the second drag pane W31 is dragged and shrunk to approximately match the corresponding second sub-window W4 on the default fourth split screen layout 4 via the second pointer tool T2. The meaning of proximately match is not limited to exactly match a sub-window. In one embodiment, the method to identify two windows with approximately similar sizes includes, without limitation, one mode, for example, the second drag pane W31 with a size 1.6 times larger than through identical to the corresponding second sub-window W4 on the fourth split screen layout 4 should be considered as a resized window with its size approximately matching the second sub-window W4 (as shown in FIG. 11).

As mentioned above, the scalable window W3 and the focal window W1 herein have same features as follows: the first drag pane W11 created with the focal window W1 is freely dragged outward by a user via the first pointer tool T1 and matches a corresponding sub-window on a default split screen layout in the system; the second drag pane W31 created with the scalable window W3 is also freely dragged inward by a user via the second pointer tool T2 and matches a corresponding sub-window on a default split screen layout in the system.

Moreover, either the first drag pane W11 or the second drag pane W31 herein may have its own borders with a distinct color by which a user can easily check current status. Furthermore, an area covered by either the first drag pane W11 or the second drag pane W31 herein may be filled with a distinct color by which a user can clearly recognize relative sizes and positions between two panes.

Accordingly, a dynamic control method for resizing sub-windows on a screen of a display has been disclosed in above embodiments. The above descriptions are preferred embodiments which do not limit the scope of a dynamic control method for resizing a sub-window; any equivalent change or improvement without departing from spirit of the present disclosure should be incorporated in claims herein.

What is claimed is:

1. A dynamic control method for resizing sub-windows on a screen of a display executed in a system and comprising steps as follows:
Step 1: Pick a focal window, which presents a first drag pane with at least a scale icon on its border, on a first split screen layout via a first pointer tool;
Step 2: Pick and hold one of said at least a scale icon as a drag origin with said first pointer tool and activate a drag action outward from said drag origin to enlarge said first drag pane;
Step 3: Enlarge said first drag pane to approximately match a corresponding first sub-window on a second split screen layout; and
Step 4: After completing said drag action, said first sub-window is displayed on said screen and a channel image in said focal window on said first split screen layout will be transmitted to said first sub-window on said second split screen layout.

2. A dynamic control method for resizing sub-windows on a screen of a display according to claim 1 is executed in a monitoring system.

3. A dynamic control method for resizing sub-windows on a screen of a display according to claim 1 wherein said system has at least two default split screen layouts.

4. A dynamic control method for resizing sub-windows on a screen of a display according to claim 1 wherein said first drag pane is enlarged according to the original size of said focal window.

5. A dynamic control method for resizing sub-windows on a screen of a display according to claim 1 wherein said first drag pane with half the size or the identical size of said corresponding first sub-window in Step 3 is considered as a resized window with its size approximately matching said first sub-window.

6. A dynamic control method for resizing sub-windows on a screen of a display according to claim 1 wherein said first pointer tool can be a mouse, a touchpad, a touch pen or a finger.

7. A dynamic control method for resizing sub-windows on a screen of a display according to claim 1 wherein said focal window, said first drag pane and said first sub-window have borders with distinct colors.

8. A dynamic control method for resizing sub-windows on a screen of a display executed in a system and comprising steps as follows:
Step 5: Pick a scalable window, which presents a second drag pane with at least a scale icon on its border, on a third split screen layout via a second pointer tool;
Step 6: Pick and hold one of said at least a scale icon as a drag origin with said second pointer tool and activate a drag action inward from said drag origin to shrink said second drag pane;
Step 7: Shrink said second drag pane to approximately match a corresponding second sub-window on a fourth split screen layout; and
Step 8: After completing said drag action, said second sub-window is displayed on said screen and a channel image in said scalable window on said third split screen layout will be transmitted to said second sub-window on said fourth split screen layout.

9. A dynamic control method for resizing sub-windows on a screen of a display according to claim 8 is executed in a monitoring system.

10. A dynamic control method for resizing sub-windows on a screen of a display according to claim 8 wherein said system has at least two default split screen layouts.

11. A dynamic control method for resizing sub-windows on a screen of a display according to claim 8 wherein said second drag pane is shrunk according to the original size of said scalable window.

12. A dynamic control method for resizing sub-windows on a screen of a display according to claim 8 wherein said second drag pane with a size 1.6 times larger than through identical to said second sub-window in Step 7 is considered as a resized window with its size approximately matching said second sub-window.

13. A dynamic control method for resizing sub-windows on a screen of a display according to claim 8 wherein said second pointer tool can be a mouse, a touchpad, a touch pen or a finger.

14. A dynamic control method for resizing sub-windows on a screen of a display according to claim 8 wherein said scalable window, said second drag pane and said second sub-window have borders with distinct colors.
